(19) United States
(12) Patent Application Publication
(10) Pub. No.: US 2018/0241182 A1
(43) Pub. Date: Aug. 23, 2018

(54) AVIONICS POWER MANAGEMENT PANEL AND DOOR ASSEMBLY

(71) Applicant: GE Aviation Systems Limited, Cheltenham (GB)

(72) Inventors: John Michael BRETT, Tewkesbury (GB); Adrian John HUGHES, Quedgeley (GB)

(21) Appl. No.: 15/888,239

(22) Filed: Feb. 5, 2018

(30) Foreign Application Priority Data
Feb. 20, 2017 (GB) 1702709.5

(51) Int. Cl. H02B 1/34; E06B 5/00; E06B 3/76

(52) U.S. Cl. CPC H02B 1/34; H02B 1/38; E06B 3/76; E06B 5/00

(57) ABSTRACT

An avionics power management panel and door assembly where the panel includes a cabinet including a set of walls at least partially defining an interior with an open face and door assembly includes a frame and central section, hingedly mounted to the cabinet and moveable between an opened position, where the interior is accessible, and a closed position where the door closes the open face wherein the frame includes a common extrusion profile.

### BACKGROUND OF THE INVENTION

Contemporary aircrafts use avionics in order to control the various equipment and operations for flying the aircraft. The avionics can include electronic components carried by a circuit board or connected to circuit breakers. The circuit boards or circuit breakers can be stored in the avionics chassis, which performs several beneficial functions, some of which are: dissipating the heat generated by the avionics or electronic components, and protecting the avionics from environmental exposure.

### BRIEF DESCRIPTION OF THE INVENTION

In one aspect, the present disclosure relates to an avionics power management panel, including a cabinet including a set of walls at least partially defining an interior with an open face and at least one door assembly having a frame and central section, moveably mounted to the cabinet and moveable between an opened position, where the interior is accessible, and a closed position where the door closes the open face wherein the frame includes opposing side sections, a top section, and a bottom section, each having a common extrusion profile and further including a set of corner braces mechanically fastened to the opposing side sections, top section, and bottom section.

In another aspect, the present disclosure relates to a door assembly for an avionics power management panel, including a frame having a first side section, a second side section, a top section, and a bottom section where the first side section, second side section, top section, and bottom section include a common extrusion profile having a main body with a channel defined therein and a branch extending from a first side of the common extrusion, a central section configured to span at least one of a length or a width of the frame and mounted to the frame and a set of corner braces where a corner brace is mechanically fastened to two of the first side section, second side section, top section, and bottom section.

In yet another aspect, the present disclosure relates to a door assembly for an avionics chassis including an aluminum frame and aluminum central section, wherein the aluminum frame includes opposing side sections, a top section, and a bottom section, each having a common extrusion profile and further including a set of aluminum corner braces mechanically fastened to the opposing side sections, top section, and bottom section wherein the door assembly is configured to support at least two of circuit breakers, printed circuit boards, or electrical relays.

### BRIEF DESCRIPTION OF THE DRAWINGS

In the drawings:

FIG. 1 is a perspective view of an aircraft having an avionics chassis in accordance with various aspects described herein.

FIG. 2 is a perspective view of an exemplary avionics chassis that can be utilized in the aircraft of FIG. 1, in accordance with various aspects described herein.

FIG. 3 is a perspective view of another exemplary avionics chassis that can be utilized in the aircraft of FIG. 1, in accordance with various aspects described herein.

FIG. 4 is a perspective view of a door assembly that can be utilized with an avionics chassis including those of FIGS. 2 and 3 in accordance with various aspects described herein.

FIG. 5 is an exploded perspective view of the door assembly of FIG. 4.

FIG. 6 is a perspective view of a frame portion of the door assembly of FIG. 4.

FIG. 7A is a cut perspective of a portion of the frame shown in FIG. 6, in a first orientation.

FIG. 7B is a cut perspective view of the portion of the frame shown in FIG. 7A, in a second orientation.

FIG. 8 is a cross-sectional view taken along line VIII-VIII of a portion of the frame portion of FIG. 6.

FIG. 9 is a perspective view of the door assembly of FIG. 4 with a printed circuit board attached.

FIG. 10 is a cut-away perspective view of a portion of the door assembly of FIG. 9.

### DETAILED DESCRIPTION

On aircraft the electrical power distribution system services various consumer loads around the aircraft. Power management panels are used to route power from the electrical power source to the electrical loads. On modern aircraft the increased number of services demands an increase in the number of components and circuits. The increased number of components and circuits leads to increased wiring for the specific loads, thereby increasing both cost and weight. Such power management panels can be relatively large weighing up to 150 lbs for which the strength to weight characteristics of the assemblies is a critical aspect in the performance of the electrical system within the demanding environment. Aspects of the disclosure describe a beneficial door assembly.

While “a set of” various elements will be described, it will be understood that “a set” can include any number of the respective elements, including only one element. Additionally, all directional references (e.g., radial, axial, upper, lower, upward, downward, left, right, lateral, front, back, top, bottom, above, below, vertical, horizontal, clockwise, counterclockwise) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order, and relative sizes reflected in the drawings attached hereto can vary.

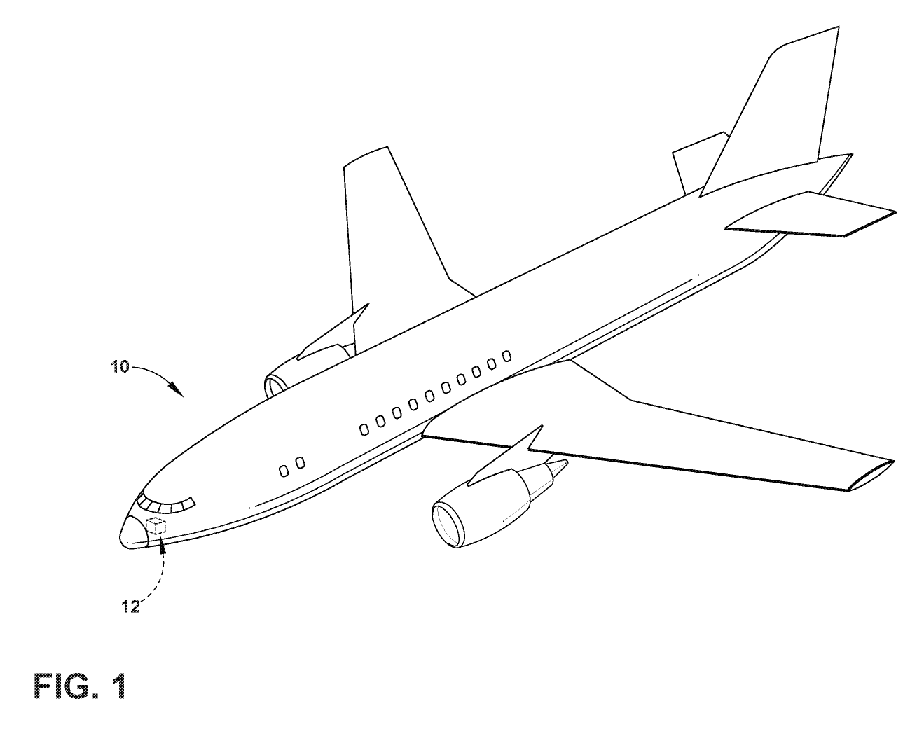

FIG. 1 schematically illustrates an aircraft 10 with an on-board avionics chassis assembly 12 (shown in dashed line), which can include a power management panel. The avionics chassis assembly 12 can house a variety of avionics elements and protect the elements against contaminants, vibrations, and the like and aids in dissipating the heat generated by the avionics or electronic components. It will be understood that the avionics chassis assembly 12 can be located anywhere within the aircraft 10, not just the nose as illustrated. For example, there can be any number of power management panels distributing power around the aircraft 10. While illustrated in a commercial airliner, the avionics chassis assembly 12 can be used in any type of aircraft, for example, without limitation, fixed-wing, rotating-wing, rocket, commercial aircraft, personal aircraft, and military aircraft. Furthermore, aspects of the disclosure are not limited only to aircraft aspects, and can be included in other mobile and stationary configurations. Non-limiting example mobile configurations can include ground-based, water-based, or additional air-based vehicles. Any implementation has its own space constraints and power requirements. As such, the design of the particular aspects of the avionics chassis assembly 12 as described herein can be tailored to suit specific installation requirements of the implementation.

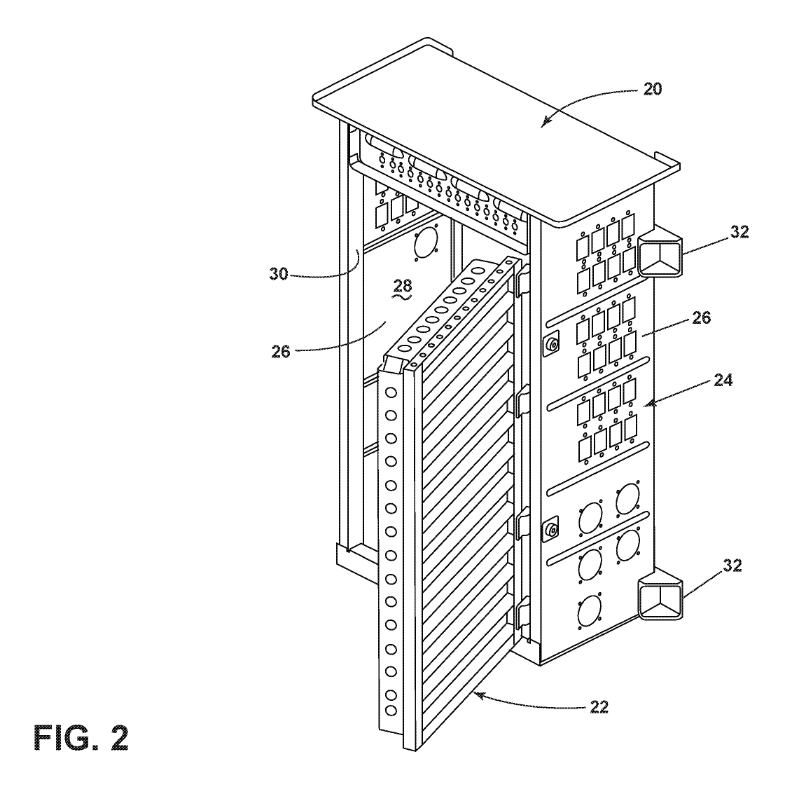

FIG. 2 illustrates an exemplary power management panel assembly 20 with a single door assembly 22 that can be utilized in the aircraft 10 of FIG. 1. The power management panel assembly 20 includes a cabinet or housing 24 including a set of walls 26 at least partially defining an interior 28 with an open face 30. A set of mounting feet 32 can extending from the housing 24 to facilitate mounting to the aircraft 10 by means of bolts or other conventional fasteners. Further, the mounting feet 32 can function as an electrical ground to ground the housing 24 to a frame of the aircraft 10 (FIG. 1). While mounting feet 32 are shown in this example, the power management panel assembly 20 can be used with many types of attachment mechanisms.

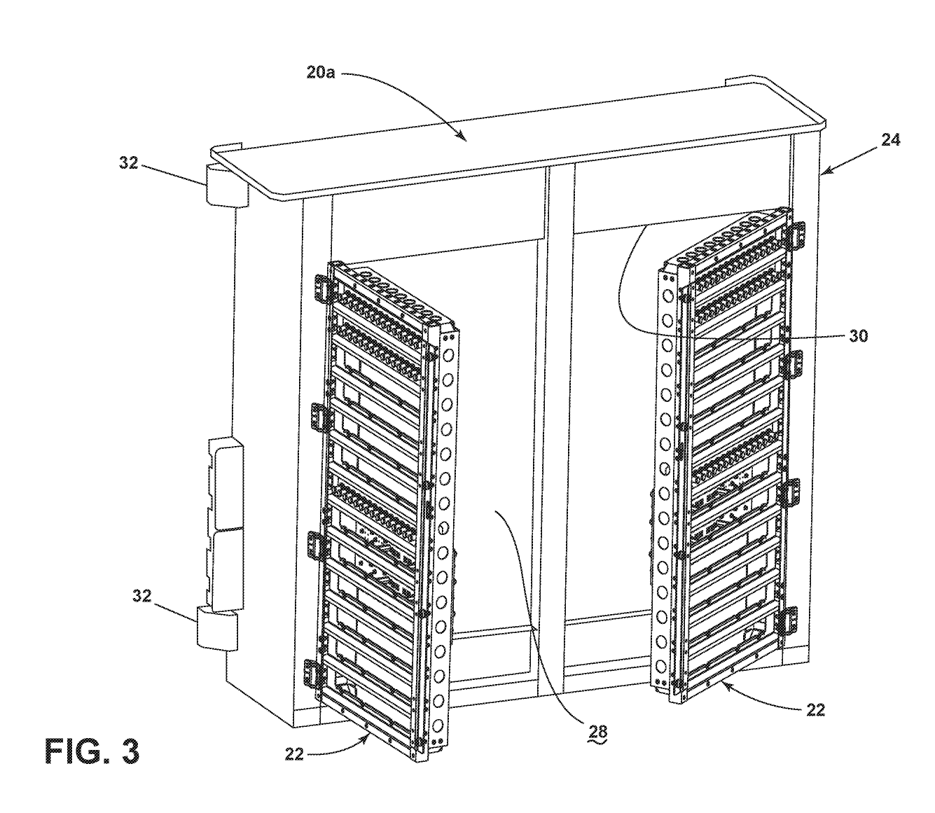

FIG. 3 is a perspective view of another exemplary power management panel assembly 20a. The power management panel assembly 20a of FIG. 3 can be substantially similar to the power management panel assembly 20 of FIG. 2. As such, the same numerals will be used to describe equivalent elements and discussion will be limited to differences between the power management panel assemblies. The main difference between the two power management panel assemblies 20, 20a is that the power management panel assembly 20a of FIG. 3 includes two door assemblies 22. In the illustrated example, the door assemblies 22 include a right hand and left hand hinged door assemblies 22. The door assembly 22 includes a common design with the parts being handed for a left or right hinge location.

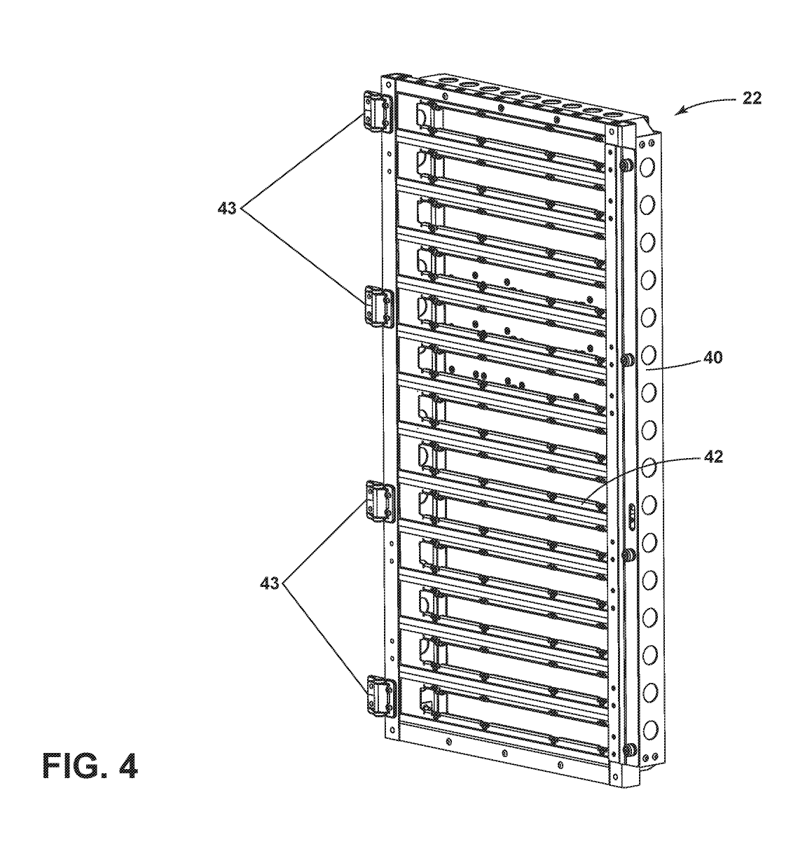

Regardless of the specifics of the housing 24 for the power management panel assembly 20a, the door assembly 22 can include a frame 40 and a central section 42 as illustrated more clearly in FIG. 4. The door assembly 22 can be moveably mounted to the housing 24 of FIG. 2 or 3. For example, a set of hinges 43 can be included on the door assembly 22 such that the door assembly 22 is pivotably mounted to the housing 24. The door assembly 22 is moveable between an opened position, where the interior 28 is accessible, and a closed position where the door assembly 22 closes the open face 30 and the interior 28 is inaccessible.

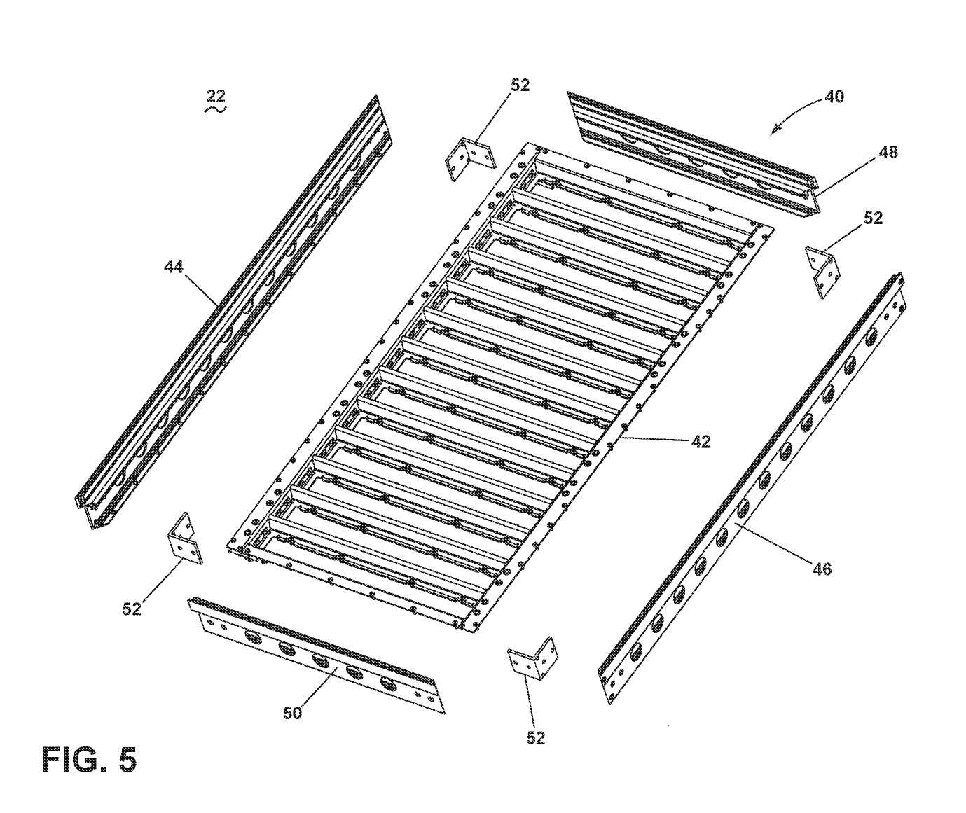

FIG. 5 is an exploded view of the door assembly of FIG. 4 more clearly showing the frame 40 including opposing side sections including a first side section 44, a second side section 46, a top section 48, and a bottom section 50. Each of the sections 44, 46, 48, and 50 forming the frame 40 have a common extrusion profile, which encompasses a common cross-sectional profile, taken perpendicular to the longitudinal length of the sections 44, 46, 48, 50 of the frame 40. That is, each of the sections 44, 46, 48, and 50 can be formed from an extruded material such that they have a matching profile. By way of non-limiting example, it is contemplated that the frame 40 can be formed from extruded aluminum.

A set of corner braces 52 are included and can be mechanically fastened to the sections 44, 46, 48, and 50. More specifically, a corner brace 52 can be utilized to connect the first side section 44 and the top section 48, to connect the first side section 44 and the bottom section 50, to connect the second side section 46 and the a top section 48, and to connect the second side section 46 and the bottom section 50.

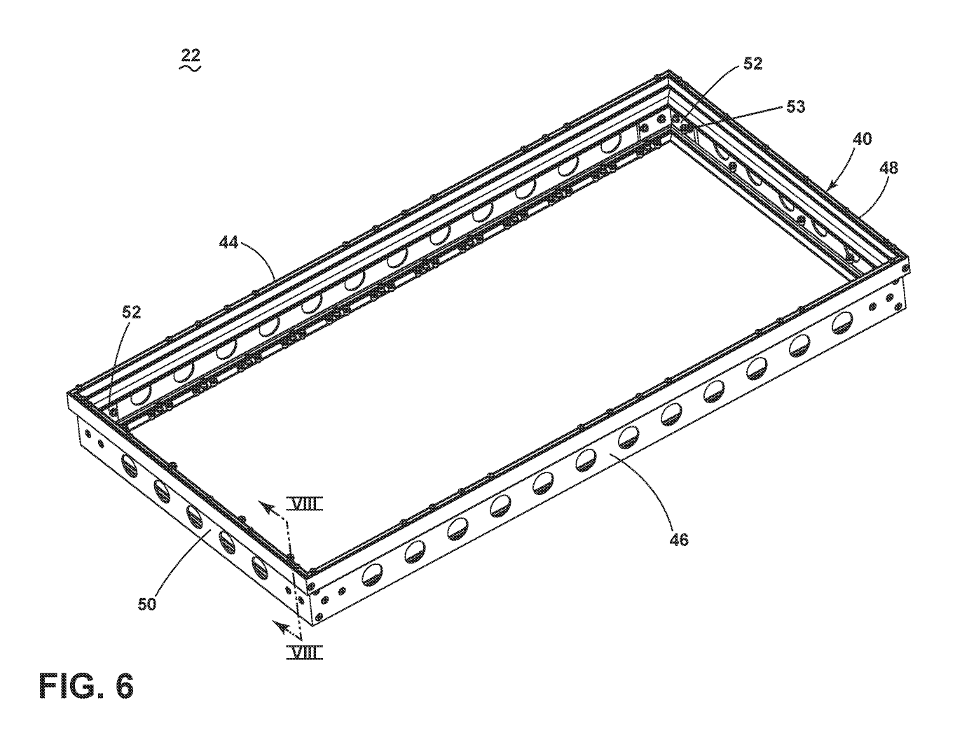

The corner braces 52 and sections 44, 46, 48, and 50 can be secured or fastened in any suitable manner. In the illustrated example of FIG. 6, the set of corner braces 52 are held in a portion of the common extrusion profile and the sections 44, 46, 48, and 50 are secured by mechanical fasteners shown as screws through the corner braces 52 in each of the four corner positions. Such mounting provides for structural integrity of the door assembly 22. A single exemplary screw 53 is included and it will be understood that any number or type of fasteners can be utilized.

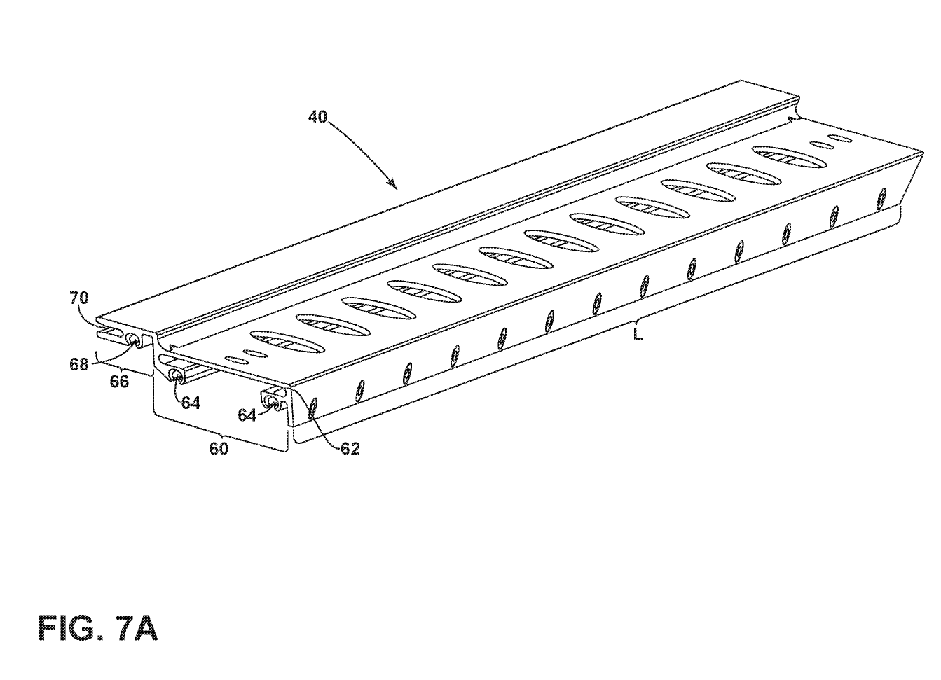

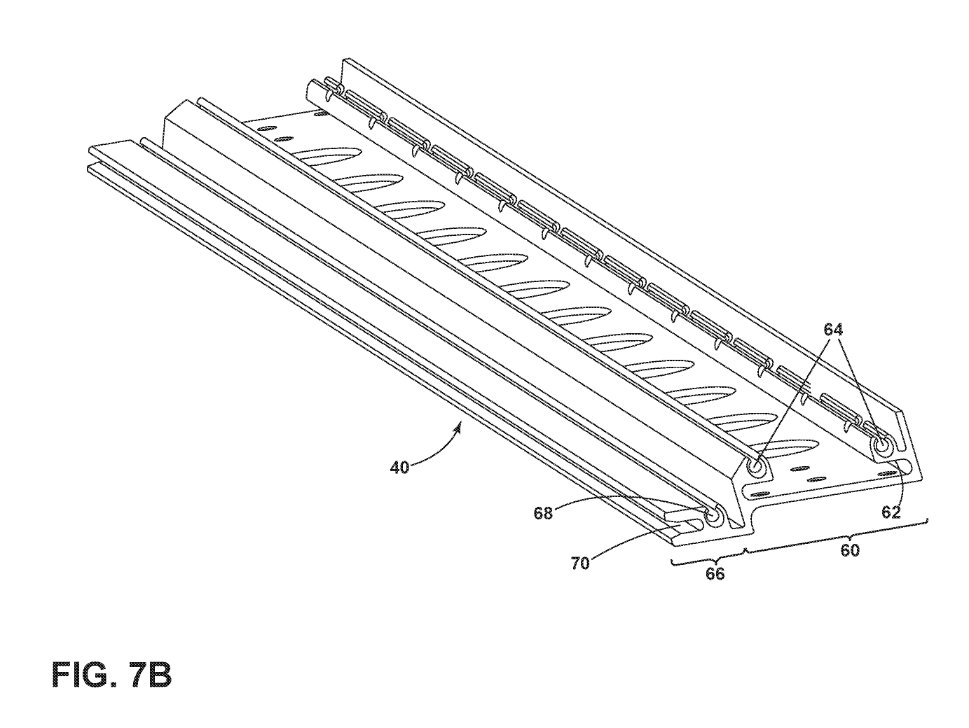

FIG. 7A is a perspective of a portion of the frame 40 shown in FIG. 6. Each of the sections 44, 46, 48, and 50 forming the frame 40 have the common extrusion profile illustrated in FIG. 7A. As such, the portion of the frame 40 shown in FIG. 7A can be representative of any of the sections 44, 46, 48, and 50. FIG. 7B illustrates the portion of the frame 40 shown in a second orientation for additional clarity. While any suitable common extrusion profile may be utilized in the sections 44, 46, 48, and 50 forming the frame 40, the common extrusion profile as illustrated includes a main body 60 with a channel 62 defined therein. The channel 62 can accommodate the L-shaped set of corner braces 52. The set of corner braces 52 of FIG. 6 can be held within the channel 62. A set of screw ports 64 run along a length (L) of the common extrusion profile for each of the sections 44, 46, 48, and 50 forming the frame 40. A branch 66 extends from a side of the main body 60. A screw port 68 is include in the branch 66 and also extends along the length of the sections 44, 46, 48, and 50 forming the frame 40. An additional screw port 70 is located on the branch 66 and is perpendicular to the other screw ports 64 and 68.

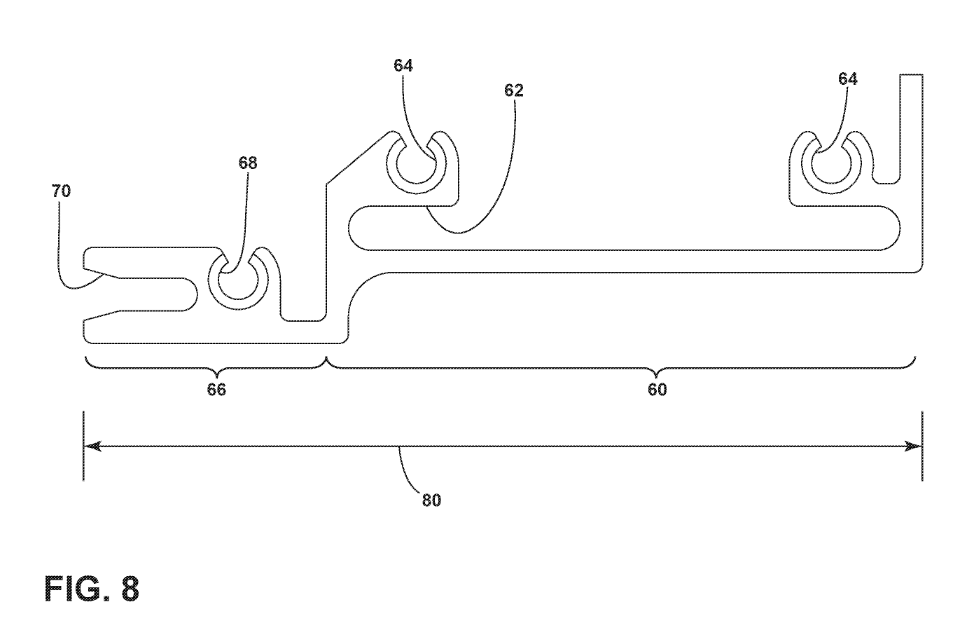

FIG. 8 illustrates a cross section taken along section VIII-VIII of FIG. 6 of the common extrusion profile of the sections 44, 46, 48, and 50 of the frame 40. FIG. 8 better illustrates the screw ports 64 and 68, which run along the length of the main body 60 and branch 66 as well as the additional screw port 70, which is perpendicular to the other screw ports 64 and 68. It will be understood that the cross section, which can be considered the common extrusion profile, is identical for each of the sections 44, 46, 48, and 50 of the frame 40. The extruded profile can have a length 80 defined as the longitudinal length of the combined main body 60 and the branch 66.

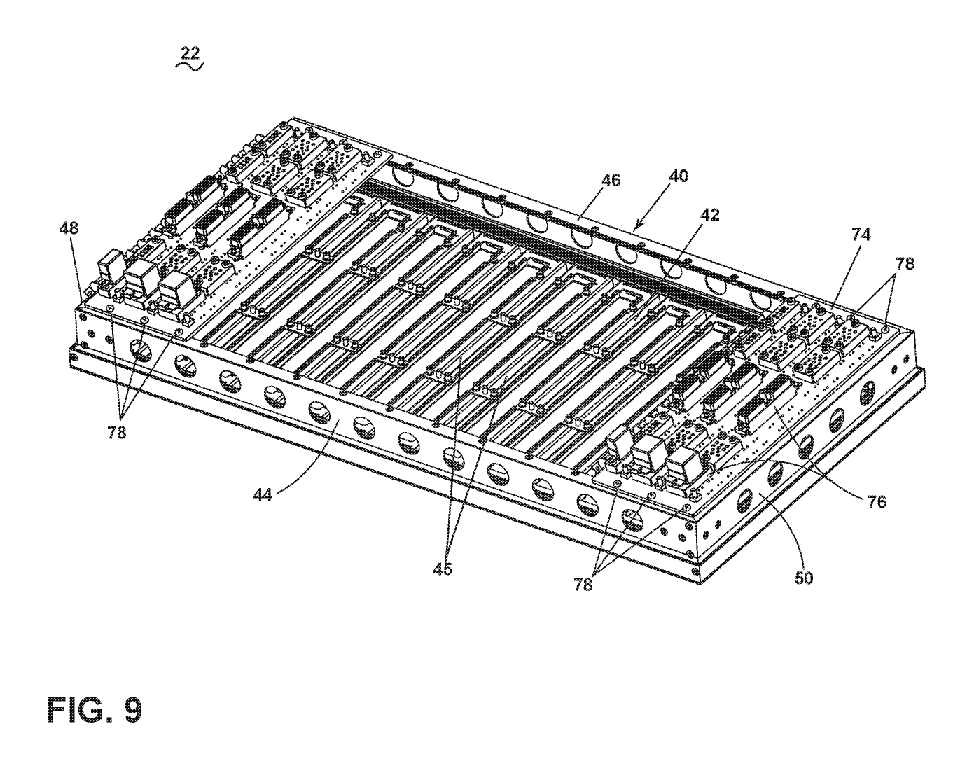

Once the sections 44, 46, 48, and 50 of the frame 40 are secured by the corner braces 52, the central section 42 is positioned into the frame 40 as illustrated in FIG. 9. The central section 42 can be formed to span at least one of a length or a width of the frame 40 and can be mounted to the frame 40. The design of the extruded profile of the frame 40 provides an efficient strength to weight solution. The frame 40 allows for the central section 48 to be formed of an aluminum sheet material with a thickness that can be as thin as 1 mm. The central section 42 can be formed in any suitable manner, such as including a saw-tooth profile as described in the concurrently-filed, commonly-owned GB Patent Application Serial No. ______, filed, 2017, entitled “Avionics power management panel and door assembly,” bearing Applicant's docket number 314568, which is incorporated herein by reference in its entirety. The central section 42 is illustrated as having a set of rows 45 to which any combination of circuit breakers, printed circuit boards, and electrical relays, in non-limiting examples, can be mounted.

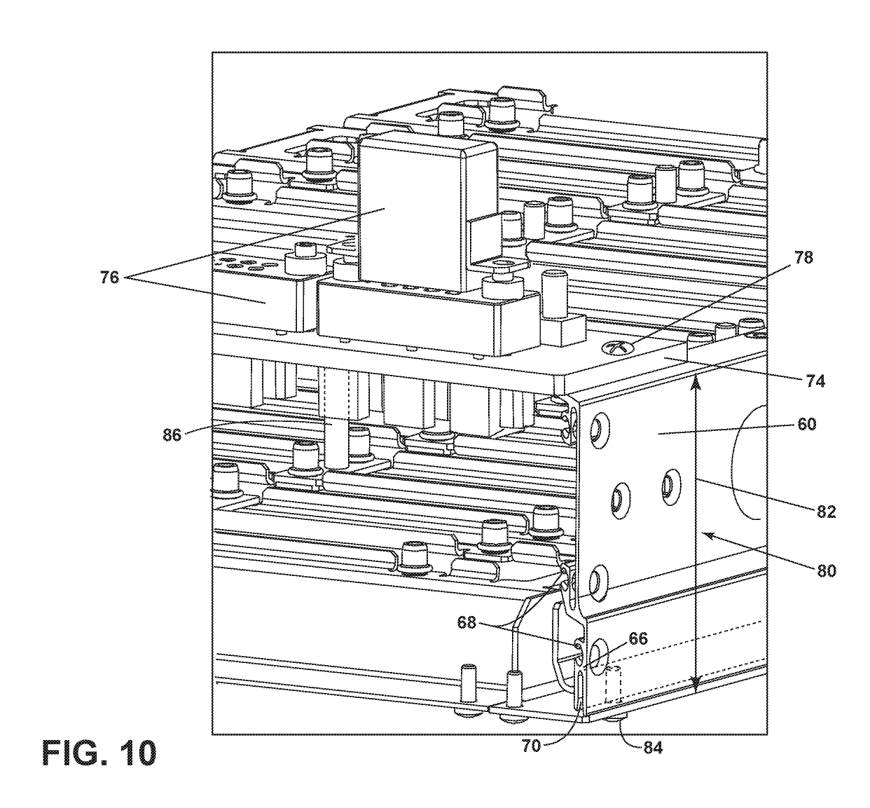

The central section 42 can then be secured to the frame 40 via mechanical fasteners 84 (FIG. 10). The first and second side sections 44, 46 and top and bottom sections 48, 50 of the central section 42, as shown in FIG. 5, sit across the screw port 70 of the frame 40 and screws into the frame 40 on all sides. As such, it does not require additional spacers or inserts to complete construction of the frame 40. Spacers can be provided for support for the attachment of electronics components, such as described in FIG. 10. The fasteners 84 can be any suitable fasteners including, but not limited to, self-tapping fasteners that can be screwed directly into the additional screw port 70. The self-tapping fasteners can screw into the additional screw port 70 within each of the sections 44, 46, 48, and 50 of the frame 40 eliminating the need for fitting threaded fasteners. It will be understood that all of the screw ports 64, 68, 70 allow for the use of self-tapping fasteners or provide opening definition for machine threading. Self-tapping fasteners, in one non-limiting example, can be metal displacement-type fasteners where no foreign object debris is generated.

Still referring to FIG. 9, once assembled, it is contemplated that the door assembly 22 as described herein can support weight in excess of 11.34 kg (25 lbs), which could see mechanical vibrations during operation, imposing a magnification factor of ten times such a weight. In the illustrated example, a set of printed circuit boards 74 having components 76 are mounted to the frame 40 via a set of fasteners 78. More specifically, external edges of the printed circuit boards 74 are fastened to a rear surface of the frame 40. It will be understood that the door assembly 22 along with the set of printed circuit boards 74 are configurable and that a printed circuit board 74 can be designed to cover and number of rows 45 of the door assembly 22. As better illustrated in FIG. 10, the printed circuit boards 74 can be supported via pillar spacers 86. It will be understood that the door assembly 22 can support any combination of circuit breakers, printed circuit boards, and electrical relays in non-limiting examples. In one example, five printed circuit boards 74 can be fitted to the door assembly 22.

During operation, the worst vibrational axis is illustrated along arrow 82, taken along the length 80 of the extruded profile, and orthogonal to the longitudinal length of the sections 44, 46, 48, and 50. Typically, the vibrational axis 82 is positioned lateral to the upright position of the power management panel assembly 20, 20a when installed in the aircraft 10 (FIG. 1). The branch 66 provides additional stiffness in the frame 40 along the vibrational axis 82 as the branch 66 provides for a deepened section 44, 46, 48, and 50 in the vibrational axis 82.

With the continual upgrading of aircrafts, there is a requirement for an increase in the number of components fitted into the exemplary power management panel assembly 20, 20a. The aspects of the present disclosure allow for a number of additional electrical parts to be supported on the door assembly 22 itself. Such parts would have previously been mounted onto the internal panel walls 26 of the power management panel assembly 20, 20a with interconnects via wiring looms as is required. The aspects of the present disclosure allow for mounting parts onto the door assembly 22 with printed circuit boards 74 used to provide the electrical interface, thus removing the need for the wiring looms. The door design and component interconnection arrangement increase the functionality of the panel assembly 20, 20a. For example, the door assemblies 22 provide structural, configurable, and maintainable support. The ability to locate a number of electrical assemblies onto the door assembly 22 closer to the electrical loads being serviced between the parts leads to a reduction of interconnect wire lengths and hence weight.

In addition to the mechanical strength provided by the common extrusion profile of the frame 40, as described herein, the door assembly 22 provides an enhanced means of thermal dissipation conducted through the printed circuit boards 74 into the frame 40 of the door assembly 22. Further still, the frame 40 is low-cost and provides a low part count. Traditionally, the door assembly is of a riveted or welded construction consisting of a number of individually manufactured parts and threaded inserts. The use of the extruded channels sections provides for a reduction in the threaded insert part count and reduces the assembly process. Thus the above described door assembly 22 provides quick and easy access to internal and external elements of panel assembly 20, 20a and environmental protection for internal parts. Additionally, structural and thermal advantages with minimal number of components and assembly functions are appreciated.

Because the door assembly 22 of the power management panel assembly 20, 20a itself supports additional electrical parts, a more compact means of high density of interfaces within a specified volume are possible. A plug-in technology for circuit breaker and interconnecting relays can be used, which improves both power to volume and power to weight ratios for a given power management panel.

Aspects of the above disclosure provide for avoidance of specific frequencies, which prevents high loads being transmitted through resonance of the assembly. More specifically, the common extrusion profile can be tailored to ensure that avoidance frequencies within the aircraft are met such that the potential high mechanical loads imposed at these resonant frequencies are limited. Further, the assembly as described herein has been designed by finite element analysis (FEA) and practical de-risk testing. The analyses are used to determine natural frequencies of the assembly as described herein. At determination of the natural frequencies, the assembly can be optimized to maintain parameters within the acceptable initial resonance frequency. Aspects of the present disclosure allow for a variety of benefits including allowing for quick and easy access to the internal and external elements of the power management panel assembly for maintenance purposes.

To the extent not already described, the different features and structures of the various aspects can be used in combination with others as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the invention, including the best mode, and also to enable any person skilled in the art to practice aspects of the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A power management panel, comprising:
an avionics power management cabinet comprising a set of walls at least partially defining an interior with an open face; and
at least one door assembly configured to mount electrical components, having a frame and central section, moveably mounted to the avionics power management cabinet and moveable between an opened position, where the interior is accessible, and a closed position where the door assembly closes the open face;
wherein the frame includes opposing side sections, a top section, and a bottom section, each having a common cross-sectional profile and further includes a set of corner braces mechanically fastened to the opposing side sections, top section, and bottom section.

2. The power management panel of claim 1, wherein the frame comprises an aluminum frame.

3. The power management panel of claim 1, wherein the common cross-sectional profile comprises a set of screw ports that run along a length of the common cross-sectional profile.

4. The power management panel of claim 3, wherein the common cross-sectional profile further includes an additional screw port that is perpendicular to the length of the common cross-sectional profile.

5. The power management panel of claim 4, wherein the central section is fastened to the frame via the additional screw port and a set of mechanical fasteners.

6. The power management panel of claim 5, wherein the mechanical fasteners include self-tapping fasteners.

7. The power management panel of claim 1, further comprising a set of printed circuit boards mounted to the frame.

8. The power management panel of claim 1, wherein the door assembly is configured to support circuit breakers, printed circuit boards, or electrical relays.

9. The power management panel of claim 1, wherein the central section comprises a sheet material that is 1 mm thick.

10. The power management panel of claim 9, wherein the door assembly is configured to support a weight in excess of 11.34 kg.

11. The power management panel of claim 1, wherein the common cross-sectional profile is an extruded common cross-sectional profile.

12. An avionics power management panel, comprising:
an avionics door assembly including a frame having a first side section, a second side section, a top section, and a bottom section where the first side section, second side section, top section, and bottom section include a common extrusion profile having a main body with a channel defined therein and a branch extending from a first side of the main body;
a central section configured to span at least one of a length or a width of the frame and mounted to the frame and where the central section is configured to mount electrical components; and
a set of corner braces where a corner brace is mechanically fastened to two of the first side section, second side section, top section, and bottom section.

13. The avionics power management panel of claim 12, wherein a set of screw ports run along a length of the common extrusion profile.

14. The avionics power management panel of claim 13, wherein the set of screw ports run along the main body and the branch.

15. The avionics power management panel of claim 13, wherein an additional screw port is located on the branch perpendicular to the length of the common extrusion profile.

16. The avionics power management panel of claim 15, wherein the central section is fastened to the frame via the additional screw port and a set of mechanical fasteners.

17. The avionics power management panel of claim 16, wherein the mechanical fasteners include self-tapping fasteners.

18. The avionics power management panel of claim 12, wherein the set of corner braces are located within the channel of the common extrusion profile of the two of the first side section, second side section, top section, and bottom section.

19. A door assembly, comprising:
an aluminum frame and aluminum central section, wherein the aluminum frame includes opposing side sections, a top section, and a bottom section, each having a common cross-sectional profile and further including a set of aluminum corner braces mechanically fastened to the opposing side sections, top section, and bottom section;
wherein the door assembly is configured for an avionics chassis to support circuit breakers, printed circuit boards, or electrical relays.

20. The door assembly of claim 19, wherein the door assembly is configured to support a weight in excess of 11.34 kg.
